(19) United States
(12) Patent Application Publication
(10) Pub. No.: US 2022/0269477 A1
(43) Pub. Date: Aug. 25, 2022

(54) REMOTE CONTROL ACCESS OF TERMINAL INTERFACE

(71) Applicant: NCR Corporation, Atlanta, GA (US)

(72) Inventors: Philip Noel Day, Fife (GB); Andrew William Douglas Smith, Dundee (GB)

(21) Appl. No.: 17/184,707

(22) Filed: Feb. 25, 2021

(51) Int. Cl. G06F 3/16; H04M 1/72409; H04L 29/08; G06F 3/0488

(52) U.S. Cl. CPC G06F 3/167; H04M 1/72409; H04L 67/28; G06F 3/04883

(57) ABSTRACT

A mobile device establishes a direct or an indirect network connection to a terminal for purposes of remotely controlling a transaction UI of the terminal. During the connection, the mobile device is operated by the user to control transaction UI element navigation, UI element selection, and UI element entry of information, which are provided from the mobile device utilizing one or more of spoken speech feedback, speech of the user, audible feedback, haptic feedback, touch selections, computer vision, and/or touch-based gestures.

### BACKGROUND

Consumers and employees of organizations have become accustomed to conducting transactions on transaction terminals, such as Self-Service Terminals (SSTs), Automated Teller Machines (ATMs), and cashier-assisted Point-Of-Sale (POS) terminals. Organizations have invested heavily in the transaction interfaces associated with these terminals to ensure transactions are conducted efficiently and without any specialized skill being required of the operators (consumers and/or cashiers/clerks/tellers).

The vast majority of transaction interfaces are provided via touchscreen displays associated with the terminals. However, with the recent world-wide COVID19 virus pandemic consumers and employees are concerned with virus transmission associated with multiple individuals all touching the same display.

Furthermore, most transaction interfaces only provide a minimal amount of accessibility features, which are required by government agencies and which allow someone with disabilities to operate the transaction interfaces. For instance, audio cords can be inserted into terminal jacks for audio-based transaction guidance to the sight impaired, the physical keys may include tactile features for navigation by the sight impaired individual, etc.

Many disabilities are not accommodated fully through government mandated regulations and for these individuals operating SSTs or ATMs remains an elusive goal. For example, someone confined to a wheelchair is likely unable to reach the touch-based transaction interface on the transaction terminals, such that operating the terminals is not possible for this type of individual.

Accessibility constraints are not just constrained to disabled customers, since many retailers now employ disabled individuals. Disabled employees often get relegated to tasks unrelated to assisting customers at transaction terminals because such individuals cannot easily access the transaction interfaces for purposes of clearing or overriding customer transactions when needed.

Thus, although transaction interfaces are easy to navigate and operate because of heavy investment and refinement by retailers, there are still a number of concerns about how these interfaces are accessed (via touch on a common screen during the pandemic) and a number of concerns about why these interfaces cannot be more widely accessible to a larger segment of the disabled community.

### SUMMARY

In various embodiments, methods and a system for remote control access to transaction terminal User Interfaces (UIs) are presented.

According to an aspect, a method for remote control of a terminal's UI is provided. Control information is provided to a mobile device for a transaction screen rendered by a transaction User Interface (UI) on a display of a transaction terminal. UI events that are generated by the mobile device are received from the mobile device and the UI events are processed by the transaction UI during a transaction at the transaction terminal.

### BRIEF DESCRIPTION OF THE DRAWINGS

FIG. 1 is a diagram of a system for remote control access and operation of a terminal's UI, according to an example embodiment.

FIG. 2 is a diagram of a method for remote control access and operation of a terminal's UI, according to an example embodiment.

FIG. 3 is a diagram of another method for remote control access and operation of a terminal's UI, according to an example embodiment.

### DETAILED DESCRIPTION

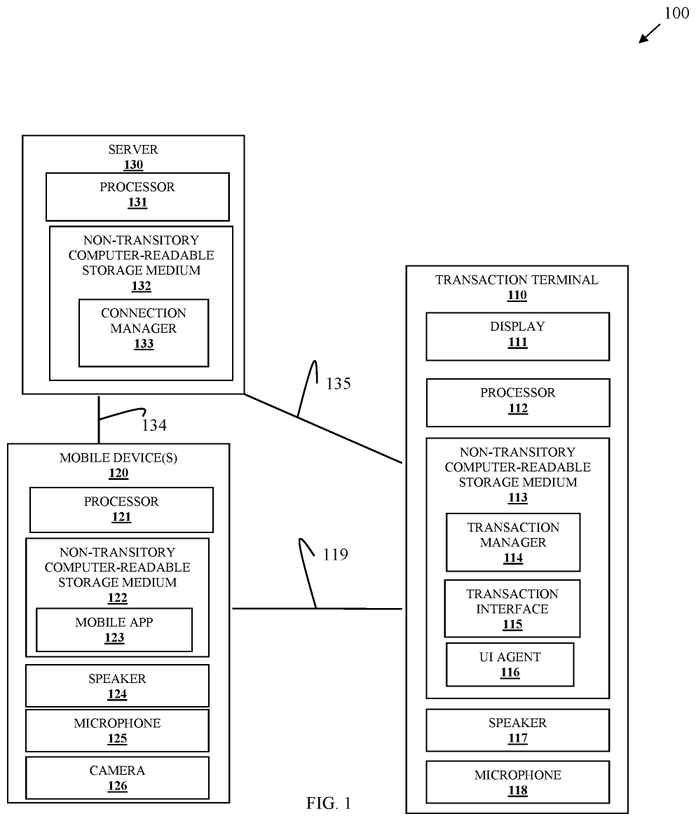

FIG. 1A is a diagram of a system 100 for remote control access and operation of a terminal's UI, according to an example embodiment. It is to be noted that the components are shown schematically in greatly simplified form, with only those components relevant to understanding of the embodiments being illustrated.

Furthermore, the various components (that are identified in the FIG. 1) are illustrated and the arrangement of the components is presented for purposes of illustration only. It is to be noted that other arrangements with more or fewer components are possible without departing from the teachings of remote-control access and operation of a terminal's UI, presented herein and below.

As used herein, a “terminal UI” may be used synonymously and interchangeably with a “transaction UI;” these phrases refer to the set of software modules that render transaction screens on a transaction display during a transaction for user-based input via selections or via entry of information. The transaction screens may be directed to customers performing transactions or employees directed to performing some administrative function (e.g., overriding or clearing) for a given transaction of a customer.

Additionally, a “UI element” comprises a software component/data structure/object associated with a navigation control, a field entry control, and/or a selection control provided by the transaction UI within any given transaction screen rendered on the transaction display during the transaction.

As will be discussed herein and below, methods 200-300 and a system 100 are provided for allowing a mobile device 120 to obtain remote navigational control of a transaction terminal's UI 115 during a transaction at the terminal 110. The mobile device 120 may be operated by a customer or an employee of the enterprise associated with the terminal 110. UI control can be achieved with (connection 119) or without a direct connection between the mobile device 120 and the terminal 110 (an indirect connection can be achieved through a server 130 using connections 134 and 135). In some cases, the mobile device 120 presents as a Human Input Device (HID) to the terminal 110 with an agent 116 on the terminal 110 provided as a driver for the HID, such that no changes are needed to an existing transaction interface on the terminal 110; rather, a mobile application (app) 123 on the mobile device translates actions of the user with respect to UI elements into UI commands forwarded to the agent 116. The agent 116 causes the UI commands to be identified by the transaction UI 115 and processed for a given transaction by a transaction manager 114 as input received from a connected HID (the mobile device 120).

Mobile app 123 provides a variety of accessibility features for the user to navigate, to select, and to enter any information needed by UI elements of the transaction UI 115; these accessibility features can be provided in combinations (multiple features provided during the transaction) or individually (a single feature provided during the transaction) by app 123. The accessibility features comprise speech-based UI element navigation and selection guidance; audible feedback; haptic feedback (such as vibrations); user provided speech for UI element navigation, selection, and entry of information; replication of a specific UI element rendered within a transaction screen of the terminal's display 111 on the display of the mobile device 120, and/or replication of transaction screens rendered on the terminal's display 111 on the display of the mobile device 120 (with or without modifications and adjustments accounting for a size difference between the display of mobile device 120 and display 111 of terminal 110).

These accessibility features provide a pandemic safe technique for operating terminals 100 (users do not repetitively touch a same surface on terminal display 111 during transactions) and the features provide a comprehensive set of accessibility options available to a wider range of disabled users (customers or employees of an enterprise). Still further, and in some cases, existing transaction UIs require no code modification because the synchronization, interaction, and remote control by the mobile device 120 is presented by UI agent 116 as a HID of terminal 110.

System 100 includes a transaction terminal 110, a mobile device 120, and a server 130.

Terminal 110 comprises a display, a processor 112, a non-transitory computer-readable storage medium 113, a speaker 117, and a microphone 118. Medium 113 comprises executable instructions for a transaction manager 114, a transaction UI 115, and UI agent 116. The executable instructions when executed by processor 112 cause processor 112 to perform operations discussed herein and below with respect to transaction manager 114, transaction UI 115, and UI agent 116.

Mobile device 120 comprises a processor 121, a non-transitory computer-readable storage medium 122, a speaker 124, a microphone 125, and a camera 126. Medium 122 comprises executable instructions for a mobile application (app) 123. The executable instructions when executed by processor 121 cause processor 121 to perform operations discussed herein and below with respect to mobile app 123.

Server 130 comprises a processor 131 and a non-transitory computer-readable storage medium 132. Medium 132 comprises executable instructions for a connection manager 133. The executable instructions when executed by processor 131 cause processor 131 to perform operations discussed herein and below with respect to connection manager 133.

Mobile device 120 can directly connect to terminal 110 over a direct connection 119. Direction connection 119 can be wired or wireless. Wireless connections many include BlueTooth®, Wi-Fi, or Near Field Communication (NFC). Mobile device 120 can also establish an indirect connection via a connection 134 between mobile device 120 and server 130 and via a connection 135 between server 130 and terminal 110. The connection 134 can be wireless, the connection 135 can be wired, wireless, or a combination of wired and wireless.

Once connected, mobile app 123 uses Application Programming Interface (API) calls to interact with UI agent 116 during a transaction of a customer or during transaction assistance by staff of an enterprise for the transaction. UI agent 116 translates the API calls into HID commands pushed on the processing stack and processed by transaction UI 115 causing a change in state in transaction screens for the transaction. Transaction manager 114 processes input and selections made within transaction UI 115 for purposes of processing a transaction or processing transaction assistance for the transaction at terminal 110.

Mobile app 123 provides a variety of accessibility options to the operator of mobile device 120. These accessibility options will now be discussed. In the accessibility options that follow, mobile app 123 interacts with UI agent 116 to receive transaction screen information that corresponds to the transaction screens being rendered on the display 111 of terminal 110. The screen information can comprise UI elements for any given screen. Mobile app 123 can either present the screens and UI elements as provided by UI agent 116 or can translate the screens and UI elements into different but equivalent screens and UI elements suitable for display on a smaller display associated with mobile device 120.

Accessibility option #1(a)—mobile app 123 provides spoken audio guidance to the operator that identifies a UI element/control that the operator current has his/her digit on (utilizing the touch display of device 120). As the operator moves his/her digit (finger or thumb) around the screen rendered on the display of device 120, any touchable/selectable UI element is vocalized through speaker 124 to the operator.

In an embodiment of option #1(a), mobile app 123 presents any UI screen being rendered on display 111 as a five option navigational and selection object, such as four arrow keys providing navigation left, right, up, and down (or previous, next, previous block, and next block); at a center of the navigational and selection object is a selection button. As the user, presses one of the arrow keys, app 123 sends the information to UI agent 116 and UI agent causes the current transaction screen rendered in the transaction UI to change focus on a UI element that corresponds to the arrow key pressed by the operator on device 120. UI agent 116 may also cause vocalization on terminal 110 over speaker 117 (or audio headset interfaced to terminal 110) to identify the current in-focus UI element that the operator navigated to from device 120. So, both device 120 and terminal 110 provide speech vocalization as to the current selected UI element so that the operator can be assured the UI element is a correct UI element that the operator wants during the transaction.

The vocalized UI elements audibly identify for the operator options during the transaction. For example, automated speech may indicate “next—search or key-in an item code; previous—assistance—requested, etc.”

In an embodiment, the pitch, tone, of the vocalized navigation and selection guidance on device 120 may be different from that which is provided as confirmation on terminal 110. Similarly, a same or different speaker's voice may be used on device 120 from that which is used on terminal 110.

Option #1(b)—mobile app 123 may provide abstract audio tones rather than vocalized speech. That is, the audio may be non-spoken and provided as tones, beeps, and/or clicks. In this embodiment, each of the option of the five option navigational and selection object can have its own unique audible sound or characteristic so as to readily identify to the operator which navigation or selection option the operator has a finger over on the display of device 120.

In an embodiment, the four options (left/previous, right/next, up/previous block, and down/next block) associated with navigation UI elements on a rendered screen by transaction UI on display 111 of terminal 110 have unique and different sounds from one another, but the fifth option (associated with selecting a UI element) may be combined with its own unique sound and vocalized speech, such as a tock sound combined with speech stating “assistance selected.”

In an embodiment, all five options of the navigational and selection object may each comprise their own unique sound and be spoken as speech to the user as well, such as a tick sound followed by speech stating, “search or key in an item.”

Option #2—mobile app 123 again provides one or both of unique abstract sounds and/or vocalized speech guidance, but app 123 also provides haptic pulses or vibrations to device 120. Here, a consistent pulse or vibration may be used for selection of a UI element with a different pulse or vibration used for activation of the UI element.

Option #3—mobile app 123 again provides haptic pulses or vibrations, but in this option different haptic pulses or vibrations are used for each of the four options (left/previous, right/next, up/previous block, and down/next block).

In an embodiment, the abstract audio feedback (tones, clicks, beeps, etc.) can be eliminated when the haptic pulses or vibrations unique identify each of the four directional/navigational options (left/previous, right/next, up/previous block, and down/next block).

Option #4—mobile app 123 does not require that the operator of mobile device 120 locate the five-option navigational and selection object rendered on a screen within the display of device 120. Instead, when the operator first touches the surface of the display on device 120, that first touch is set to the center or selection option of the five-option navigational and selection object. The operator then utilizes touch gestures to move their digit up, down, left, and right from the initial touched location. Swipes to the left, right, up, or down may also be used. App 123 interprets the touch gestures or swipes as one of the four directional options being selected by the operator; a double tap can indicate a selection of a given UI element.

Any of the above-mentioned options (#1-#3) may also be combined and used with option #4 (vocalized speech feedback (from device 120 and/or terminal 110), abstract audible feedback, and/or haptic (pulse or vibration) feedback).

Option #5—mobile app 123 utilizes camera 126 and images provided by the camera 126 for purposes of identifying the UI elements presented within a rendered transaction screen on display 111 of terminal 110 by transaction UI 115 during the transaction. App 123 processes the images to identify the UI elements within a defined zone. The operator moves the device 120 around with the camera 126 pointed at the rendered screen on display 111. App 123 maintains a selection guidance rectangle or square to distinguish which UI element is present within the rectangle or square as being within the defined zone.

In an embodiment, this can be used in combination with vocalized speech navigation and selection feedback.

In an embodiment, this can be used within any of options #1-#4 presented above.

This option is particularly useful to operators confined to a wheelchair.

Current UI elements brought within focus of the zone can be selected by the operator of device 120 by double-tapping anywhere on the surface of the display of mobile device 120, by operator voice instruction, and/or by pressing a physical button on device 120 (such as a home button, a volume button, etc.).

In an embodiment, in order to assist app 123 in readily identifying UI elements rendered within a transaction screen on display 111 of terminal 110 by transaction UI 115, transaction UI 115 is enhanced to present a small Quick Response (QR) code at the bottom of each UI element (bottom left or bottom right). In this case, app 123 only need decode the QR code to identify the UI element within the zone of the captured image.

In another case, transaction UI 115 is enhanced to visual present each UI element with its own unique shape, outline, or color pattern. This information can be processed by app 123 to readily identify UI elements within the zone of the captured image.

Option #6—mobile app 123 permits remote control of the UI elements of transaction UI through speech-based feedback and through operator speech commands. This can be used in combination with audio cords and or audio headsets of mobile device 120 (the headsets may include their own integrated microphone). A headset speaker, speaker 124, and/or speaker 117 can be used to play the speech-based feedback to the operator. A headset microphone, microphone 125, and/or microphone 118 can be used to receive the operator speech commands for processing.

In an embodiment, each newly rendered transaction screen by transaction UI 111 on display 111 of terminal 110 is described by speech feedback to the operator. For example, “this is the main shopping screen, scan your items, or say ‘search’ to lookup items or say ‘assistance” if you need help.”

In an embodiment, each UI element presented within a rendered screen by transaction UI 111 on display 111 of terminal 110 is described by speech feedback to the operator as the operator navigates a give set of UI elements within a given screen. The user navigates and selects via operator-provided speech commands. For example, the operator may say “next, next, yes” to navigate a screen with multiple UI elements and select a particular UI element for activation.

Option #7—mobile app 123 replicates all of a given UI transaction screen or a portion of the UI transaction screen on the display of mobile device 120.

With this option, each UI screen is associated with a visual description schema and a speech description schema. Each UI element within a given screen comprises a visual description schema and a speech description schema. This permits app 123 to resize the UI screens for presentation on the display of device 120 and permits speech-based feedback through speaker 124 to the operator of device 120.

In an embodiment, app 123 exploits or uses the built-in VoiceOver® or TalkAloud® features of the Operating System (OS) on device 120. That is, the speech feedback for guidance and selection can be provided through the existing features of the device 120.

In an embodiment, only a single UI element of a single UI transaction screen is replicated on device 120 through image recognition of the UI element or through use of the QR code discussed above with option #5. This may particularly useful to a disabled staff member that is attempting to override an error during a transaction for a customer at terminal 110. The disabled staff member confined to a wheelchair uses device 120 to scan the QR code of the UI element that is needed for the override and interacts with the UI element on device 120 to perform a transaction override on behalf of the customer.

System 100 provides a wide-range of accessibility features to disabled individuals (sight impaired or confined to a wheelchair (limited reach to access display 111 of terminal 110)) by allowing the individuals to interact with the transaction UI 115 of terminal 110 via their-own device 120. System 100 also provides a COVID19 safe mechanism by which transactions can be completed without multiple individuals repetitively touching a same surface of display 111 for terminal 110.

In an embodiment, transaction terminal 110 is a Self-Service Terminal (SST), an Automated Teller Machine (ATM), a Point-Of-Sale (POS) terminal, a kiosk, or a gaming terminal.

In an embodiment, mobile device 120 is a phone, a tablet, a laptop, or a wearable processing device.

In an embodiment, device 120 and terminal 110 connect for a remote-controlled transaction via device 120 indirectly through server 130 over connections 134 and 135. With connection manager 133 processing as a proxy to the indirect connection.

In an embodiment, an initial splash screen of transaction UI comprises a QR code, when app 120 detects the QR code a direct connection 119 or an indirect connection 134 and 135 is established between device 120 and terminal 110.

In an embodiment, an NFC tap by device 120 on or near terminal 110 creates a direct connection 119 or an indirect connection 134 and 135 between device 120 and terminal 110.

In an embodiment, direct connections 119 can be via Bluetooth®, NFC, or Wi-Fi.

In an embodiment, a first part of an indirect connection 134 between device 120 and server 130 can be via Bluetooth®, NFC, or Wi-Fi.

In an embodiment, a second part of indirection connection 135 between server 130 and terminal 110 can be wireless, wired, or a combination of both wired and wireless.

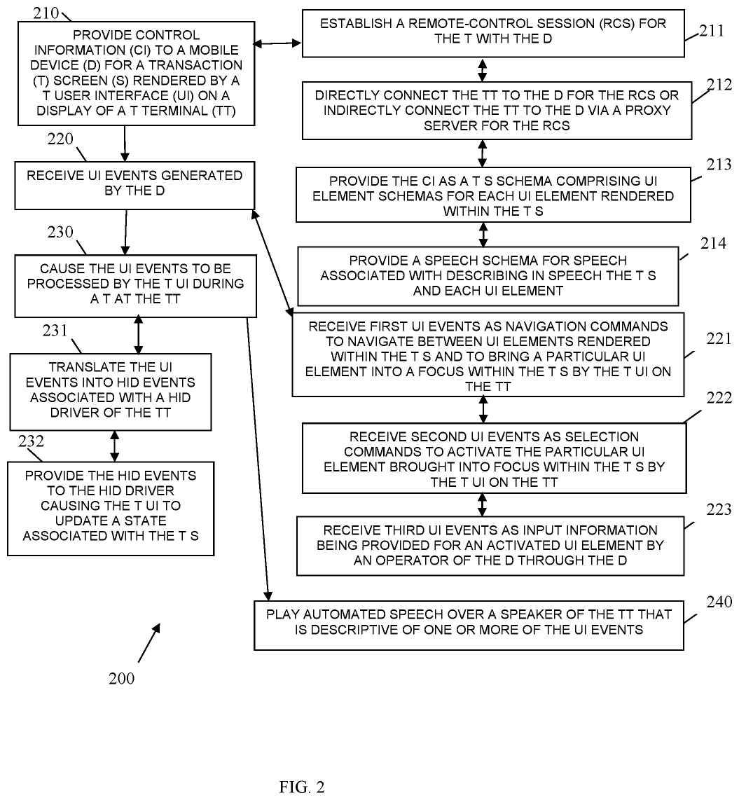

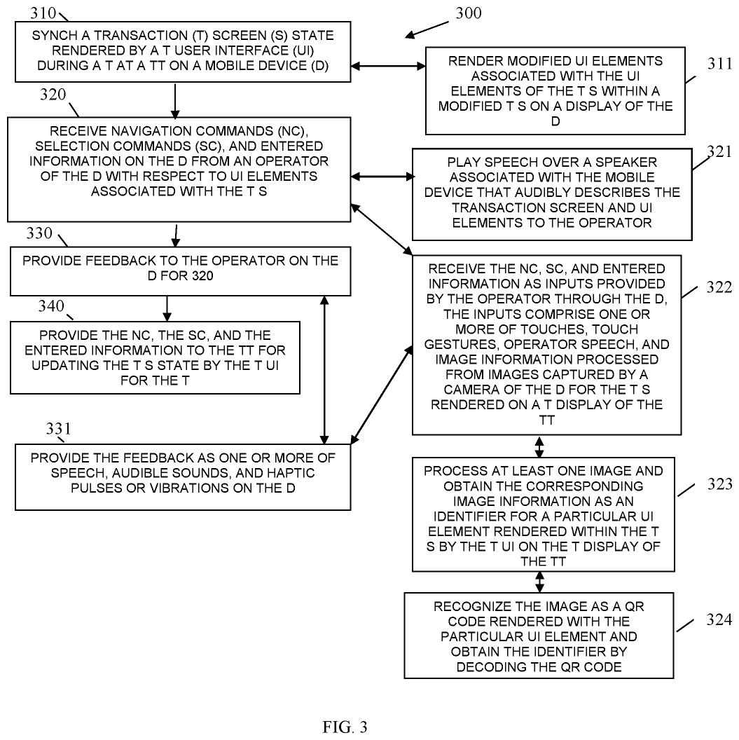

The above-noted embodiments and other embodiments are now discussed with FIGS. 2-3.

FIG. 2 is a diagram of a method 200 for remote control access and operation of a terminal's UI, according to an example embodiment. The software module(s) that implements the method 200 is referred to as a “transaction terminal UI agent.” The transaction terminal UI agent is implemented as executable instructions programmed and residing within memory and/or a non-transitory computer-readable (processor-readable) storage medium and executed by one or more processors of a transaction terminal. The processor(s) of the device that executes the transaction terminal UI agent are specifically configured and programmed to process the transaction terminal UI agent. The transaction terminal UI agent may have access to one or more network connections during its processing. The network connections can be wired, wireless, or a combination of wired and wireless.

In an embodiment, the transaction terminal UI agent executes on transaction terminal 110. In an embodiment, the terminal 110 is a POS terminal, a SST, an ATM, a kiosk, or a gaming terminal/device.

In an embodiment, the transaction terminal UI agent is UI agent 116.

At 210, the transaction terminal UI agent provides control information to a mobile device for a transaction screen that is rendered by a transaction user interface on a display of a transaction terminal.

In an embodiment, at 211, the transaction terminal UI agent establishes a remote-control session for the transaction terminal with the mobile device.

In an embodiment of 211 and at 212, the transaction terminal UI agent directly connects the transaction terminal to the mobile device for the remote-control session or the transaction terminal UI agent indirectly connects the transaction terminal to the mobile device via a proxy server for the remote control session.

In an embodiment of 212 and at 213, the transaction terminal UI agent provides the control information as a transaction screen schema comprising UI element schemas for each UI element rendered within the transaction screen by the transaction UI.

In an embodiment of 213 and at 214, the transaction terminal UI agent provides a speech schema for speech associated with describing in speech the transaction screen and each UI element of the transaction screen.

At 220, the transaction terminal UI agent receives UI events generated by the mobile device.

In an embodiment, at 221, the transaction terminal UI agent receives first UI events as navigation commands to navigate between UI elements rendered within the transaction screen and to bring a particular UI element into a focus state within the transaction screen by the transaction UI on the transaction terminal.

In an embodiment of 221 and at 222, the transaction terminal UI agent receives second UI events as selection commands to activate the particular UI element brought into focus within the transaction screen by the transaction UI on the transaction terminal.

In an embodiment of 222 and at 223, the transaction terminal UI agent receives third UI events as input information being provided for an activated UI element by an operator of the mobile device through the mobile device.

At 230, the transaction terminal UI agent causes the UI events to be processed by the transaction UI during a transaction at the transaction terminal.

In an embodiment, at 231, the transaction terminal UI agent translates the UI events into HID events associated with a HID driver of the transaction terminal.

In an embodiment of 231 and at 232, the transaction terminal UI agent provides the HID events to the HID driver causing the transaction UI to update a state associated with the transaction screen.

According to an embodiment, at 240, the transaction terminal UI agent plays automatically generated speech over a speaker of the transaction terminal that is descriptive of one or more of the UI events as speech feedback provided from the transaction terminal during the transaction to an operator of the mobile device.

FIG. 3 is a diagram of a method 300 for remote control access and operation of a terminal's UI, according to an example embodiment. The software module(s) that implements the method 300 is referred to as a “transaction UI mobile app.” The transaction UI mobile app is implemented as executable instructions programmed and residing within memory and/or a non-transitory computer-readable (processor-readable) storage medium and executed by one or more processors of a mobile device. The processor(s) of the device that executes the transaction UI mobile app are specifically configured and programmed to process the transaction UI mobile app. The transaction UI mobile app may have access to one or more network connections during its processing. The network connections can be wired, wireless, or a combination of wired and wireless.

In an embodiment, the mobile device that executes the transaction UI mobile app is mobile device 120. In an embodiment, the mobile device 120 is a phone, a tablet, a laptop, or a wearable processing device.

In an embodiment, the transaction UI mobile app is app 123.

Transaction UI mobile app interacts with UI agent 116 and/or method 200 directly (119) indirectly (134 and 135) over a network for purposes of navigating and controlling transaction UI 115 during a transaction at a transaction terminal 110.

At 310, the transaction UI mobile app synchronizes a transaction screen state associated with a transaction screen that is rendered by a transaction UI during a transaction at a transaction terminal on a mobile device (the mobile device that is executing the transaction UI mobile app).

In an embodiment, at 311, the transaction UI mobile app renders modified UI elements associated with the UI elements of the transaction screen within a modified transaction screen on a display of the mobile device. In an embodiment, the modified UI elements comprise the five-option navigation (4 directional options) and selection (1 selection option) object discussed above with embodiments of system 100.

At 320, the transaction UI mobile app receives navigation commands, selection commands, and entered information on the mobile device from an operator of the mobile device with respect to UI elements associated with the transaction screen that is rendered on the transaction terminal.

In an embodiment, at 321, the transaction UI mobile app plays speech over a speaker associated with the mobile device that audibly describes in a human spoken language the transaction screen and UI elements of the transaction screen to the operator of the mobile device. The speaker can be an integrated speaker of the mobile device or a connected headset that is connected to the mobile device and worn by the operator during the transaction.

In an embodiment, at 322, the transaction UI mobile app receives the navigation commands, the selection commands, and the entered information as inputs provided by the operator through the mobile device. The inputs comprise one or more of: touches, touch gestures, operator speech, and image information processed from images captured by a camera of the mobile device for the transaction screen rendered on a transaction display of the transaction terminal.

In an embodiment of 322 and at 323, the transaction UI mobile app processes at least one image and obtains the corresponding image information as an identifier for a particular UI element rendered within the transaction screen by the transaction UI on the transaction display of the transaction terminal.

In an embodiment of 323 and at 324, the transaction UI mobile app recognizes the image as a QR code rendered with the particular UI element and the transaction UI mobile app obtains the identifier for the particular UI element by decoding the QR code.

At 330, the transaction UI mobile app interactively and dynamically provides feedback to the operator on the device during 320.

In an embodiment of 322 and 330, at 331, the transaction UI mobile app provides the feedback as one or more of speech, audible sounds, and haptic pulses or vibrations on the mobile device.

At 340, the transaction UI mobile app provides the navigation commands, the selection commands, and the entered information to the transaction terminal for updating the transaction screen state of the transaction screen by the transaction UI for the transaction.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
providing control information to a mobile device for a transaction screen rendered by a transaction User Interface (UI) on a display of a transaction terminal via a wireless connection to the mobile device;
receiving user-interface (UI) events generated by the mobile device;
causing the UI events to be processed by the transaction UI during a transaction at the transaction terminal; and
processing the method without any source code changes being made to the transaction UI and wherein the transaction UI is an existing transaction UI.

2. The method of claim 1, wherein providing further includes establishing a remote-control session for the transaction with the mobile device.

3. The method of claim 2, wherein establishing further includes directly connecting the transaction terminal to the mobile device for the remote-control session or indirectly connecting the transaction terminal to the mobile device via a proxy server for the remote-control session.

4. The method of claim 3, wherein establishing further includes providing the control information as a transaction screen schema comprising UI element schemas for each UI element rendered within the transaction screen.

5. The method of claim 4, wherein providing the control information further includes providing a speech schema for speech associated with describing in speech the transaction screen and each UI element.

6. The method of claim 1, wherein receiving further includes receiving first UI events as navigation commands to navigate between UI elements rendered within the transaction screen and to bring a particular UI element into a focus by the transaction UI within the transaction screen on the transaction terminal.

7. The method of claim 6, wherein receiving further includes receiving second UI events as selection commands to activate the particular UI element brought into the focus within the transaction screen by the transaction UI on the transaction terminal.

8. The method of claim 7, wherein receiving further includes receiving third UI events as input information being provided for an activated UI element by an operator of the mobile device through the mobile device.

9. The method of claim 1, wherein causing further includes translating the UI events into Human Input Device (HID) events associated with a HID driver of the transaction terminal.

10. The method of claim 9, wherein translating further includes providing the HID events to the HID driver causing the transaction UI to update a state associated with the transaction screen.

11. The method of claim 1 further comprising, playing automated speech over a speaker of the transaction terminal that is descriptive of one or more of the UI events.

12. A method, comprising:
synching a transaction screen state for a transaction screen rendered by a transaction User Interface (UI) of a transaction terminal during a transaction at the transaction terminal on a mobile device over a wireless connection maintained to the mobile device;
receiving navigation commands, selection commands, and entered information on the mobile device from on operator of the mobile device with respect UI elements associated with the transaction screen;
providing feedback to the operator on the mobile device for the receiving;
providing the navigation commands, the selection commands, and the entered information to the transaction terminal for updating the transaction screen state by the transaction UI for the transaction; and
processing the method without any source code changes being made to the transaction UI and wherein the transaction UI is an existing transaction UI.

13. The method of claim 12, wherein synching further includes rendering modified UI elements associated with the UI elements of the transaction screen within a modified transaction screen on a display of the mobile device.

14. The method of claim 12, wherein receiving further includes playing speech over a speaker associated with the mobile device that audibly describes the transaction screen and the UI elements to the operator.

15. The method of claim 12, wherein receiving further includes receiving the navigation commands, the selection commands, and the entered information as inputs provided by the operator through the mobile device, wherein the inputs comprise one or more of: touches of the operator, touch gestures of the operator, operator speech, and image information processed from images captured by a camera of the mobile device for the transaction screen rendered on a transaction display of the transaction terminal.

16. The method of claim 15, wherein receiving further includes processing at least one image and obtaining the corresponding image information as an identifier for a particular UI element rendered within the transaction screen by the transaction UI on the transaction display of the transaction terminal.

17. The method of claim 16, wherein processing the at least one image further includes recognizing the at least one image as a Quick Response (QR) code rendered with the particular UI element and obtaining the identifier by decoding the QR code.

18. The method of claim 15, wherein providing the feedback further includes providing the feedback as one or more of speech, audible sounds, and haptic pulses or vibrations on the mobile device.

19. A system comprising:
a transaction terminal comprising a processor and a non-transitory computer-readable storage medium;
the non-transitory computer-readable medium comprising executable instructions; and
the executable instructions when executed by the processor from the non-transitory computer-readable storage medium cause the processor to perform operations comprising:
providing control information to a mobile device for a transaction screen rendered by a transaction User Interface (UI) on a display of the transaction terminal via a wireless connection to the mobile device;
receiving UI events generated by the mobile device;
translating the UI events to Human Interface Device (HID) events associated with a HID of the transaction terminal;
providing the HID events to a HID driver for the HID causing the HID events to be processed by the transaction UI and updating a state associated with the transaction screen rendered on the display during a transaction at the transaction terminal; and
processing the executable instructions without any source code changes to the transaction UI, wherein the transaction UI is an existing transaction UI of the transaction terminal.

20. The system of claim 19, wherein the transaction terminal is one of: An Automated Teller Machine (ATM), a Point-Of-Sale (POS) terminal, a Self-Service Terminal (SST), or a gaming terminal.
